(19) United States
(12) Patent Application Publication
(10) Pub. No.: US 2015/0143544 A1
(43) Pub. Date: May 21, 2015

(54) APPARATUSES, METHODS, AND BROWSERS BROWSER DATA PROTECTION

(71) Applicant: Tencent Technology (Shenzhen) Company Limited, Shenzhen (CN)

(72) Inventor: Jinggang LU, Shenzhen (CN)

(73) Assignee: Tencent Technology (Shenzhen) Company Limited, Shenzhen (CN)

(21) Appl. No.: 14/607,922

(22) Filed: Jan. 28, 2015

Related U.S. Application Data
(63) Continuation of application No. PCT/CN2014/075032, filed on Apr. 10, 2014.

(30) Foreign Application Priority Data
Jun. 28, 2013 (CN) 201310269538.8

(51) Int. Cl. H04L 29/06; H04L 29/08

(52) U.S. Cl. CPC H04L 63/10; H04L 67/10
USPC 726/29

(57) ABSTRACT

A terminal device may include a storage medium and a processor. The processor may be configured to execute instructions stored in the storage medium to operate a browser under an instruction of a user of the terminal, wherein the browser may include a private mode and a non-private mode; obtain data generated by an operation of the browser by the user; and switch the browser from the non-private mode to the private mode in response to a private mode entry instruction received from the user. When the terminal device receives a data display request from the user, the processor may display the data obtained when the browser is in the private mode and the data obtained when the browser is in the non-private mode together when the browser is in the private mode; and display the data obtained when the browser is in the non-private mode only when the browser is in the non-private mode.

### PRIORITY STATEMENT

This application is a continuation of International Application No. PCT/CN2014/075032, filed on Apr. 10, 2014, in the State Intellectual Property Office of the People's Republic of China, which claims the priority benefit of Chinese Patent Application No. 201310269538.8 filed on Jun. 28, 2013, the disclosures of which are incorporated herein in their entirety by reference.

### FIELD

The present disclosure relates to communication. Specifically, the present disclosure relates to apparatuses and methods of browser data protection.

### BACKGROUND

Terminal devices, such as cell phones, home computers, and laptops, have already become necessities of modern life and bring great convenience to people's lives and work. But many software applications installed on a terminal are designed without considering user's privacy protection. For example, a user may install a browser and browse web pages using the browser. However, the data generated during operation of the browser by the user (e.g., the history, bookmarks, cookies, and other personal data) is generally not confidential. Personal information of a user is easily exposed, and data confidentiality is low.

### SUMMARY

According to an aspect of the present disclosure, a terminal device may include a storage medium and a processor. The processor may be configured to execute instructions stored in the storage medium to operate a browser under an instruction of a user of the terminal, wherein the browser may include a private mode and a non-private mode; obtain data generated by an operation of the browser by the user; and switch the browser from the non-private mode to the private mode in response to a private mode entry instruction received from the user. When the terminal device receives a data display request from the user, the processor may display the data obtained when the browser is in the private mode and the data obtained when the browser is in the non-private mode together when the browser is in the private mode; and display the data obtained when the browser is in the non-private mode only when the browser is in the non-private mode.

According to another aspect of the present disclosure, a method for browser data protection may include providing to a user a browser operating in a terminal device, wherein the terminal device may include a processor, and the browser includes a private mode and a non-private mode. The method may further comprise obtaining data generated by an operation of the browser by the user; and switching the browser from the non-private mode to the private mode in response to a private mode entry instruction received from the user. When the terminal receives a data display request from the user, the method may further comprise displaying the data obtained when the browser is operated in the private mode and the data obtained when the browser is in the non-private mode together in response to the data display request when the browser is in the private mode; and displaying the data obtained when the browser is in the non-private mode only in response to the data display request when the browser is in the non-private mode.

According to yet another aspect of the present disclosure, a non-transitory processor-readable storage medium may include at least one set of instructions for browser data protection. The at least one set of instructions may be configured to direct a processor to perform acts of providing a browser operating in a terminal device to a user, wherein the browser may include a private mode and a non-private mode. The at least one set of instructions may be configured to direct the processor to perform acts of obtaining data generated by an operation of the browser by the user; and switching the browser from the non-private mode to the private mode in response to a private mode entry instruction received from the user. When the processor receives a data display request from the user, the processor may perform acts of displaying the data obtained when the browser is operated in the private mode and the data obtained when the browser is in the non-private mode together in response to the data display request when the browser is in the private mode; and displaying the data obtained when the browser is in the non-private mode only in response to the data display request when the browser is in the non-private mode.

### DESCRIPTIONS OF THE DRAWINGS

The above and other features and advantages will become more apparent by describing in detail example embodiments thereof with reference to the attached drawings in which:

FIG. 1 is a schematic diagram of a method for browser data protection according to example embodiments of the present disclosure;

FIG. 2 is another schematic diagram of a method for browser data protection according the example embodiments of the present disclosure;

FIG. 3 is yet another schematic diagram of a method for browser data protection according to the example embodiments of the present disclosure;

FIG. 4 is a schematic diagram of a structure of a browser according to the example embodiments of the present disclosure;

FIG. 5 is another schematic diagram of the structure of a browser according to the example embodiments of the present disclosure;

FIG. 6 is yet another schematic diagram of the structure of a browser according to the example embodiments of the present disclosure; and

FIG. 7 is a schematic diagram illustrating an example embodiment of a terminal device.

### DETAILED DESCRIPTION OF THE INVENTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

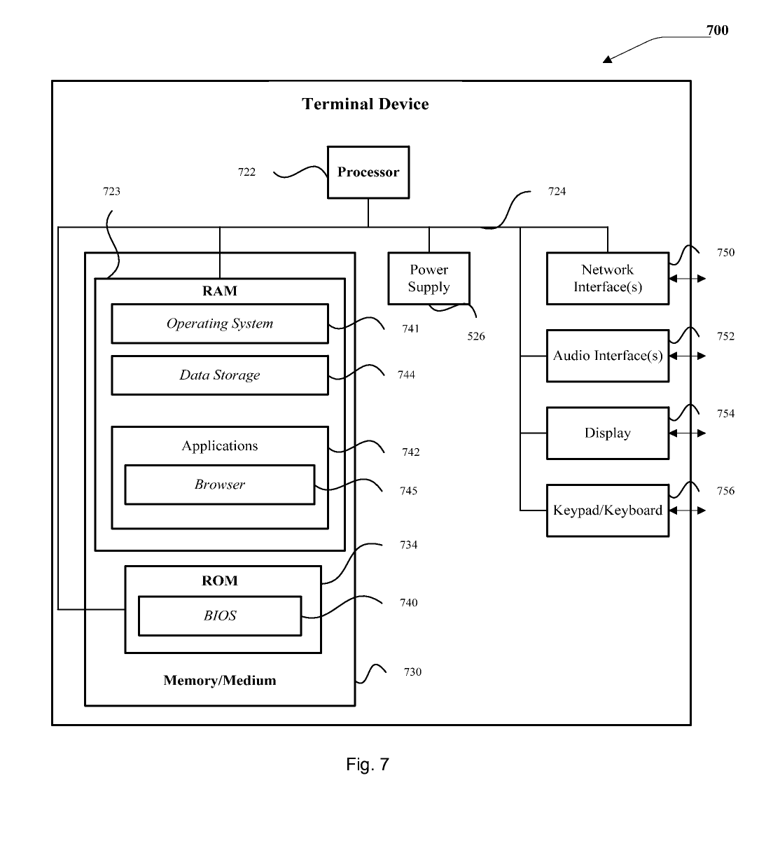

FIG. 7 is a schematic diagram illustrating an example embodiment of a terminal device (hereinafter “terminal”). The terminal may include apparatuses to execute methods and software systems introduced in the present disclosure. A terminal 700 may be a computing device capable of executing a software system. The terminal 700 may, for example, be a device such as a personal desktop computer or a portable device, such as a laptop computer, a tablet computer, a cellular telephone, or a smart phone.

The terminal 700 may vary in terms of capabilities or features. Claimed subject matter is intended to cover a wide range of potential variations. For example, the terminal 700 may include a keypad/keyboard 756. It may also include a display 754, such as a liquid crystal display (LCD), or a display with a high degree of functionality, such as a touch-sensitive color 2D or 3D display. In contrast, however, as another example, a web-enabled terminal 700 may include one or more physical or virtual keyboards, and mass storage medium 730.

The terminal 700 may also include or may execute a variety of operating systems 741, including an operating system, such as a Windows™ or Linux™, or a mobile operating system, such as iOS™, Android™, or Windows Mobile™. The terminal 700 may include or may execute a variety of possible applications 742, such as a browser 745. An application 742 may enable communication with other devices via a network, such as communicating with another computer, another terminal, or server via a network.

Further, the terminal 700 may include one or more non-transitory processor-readable storage media 730 and one or more processors 722 in communication with the non-transitory processor-readable storage media 730. For example, the non-transitory processor-readable storage media 730 may be a RAM memory, flash memory, ROM 734, 740 memory, EPROM memory, EEPROM memory, registers, hard disk, a removable disk, a CD-ROM, or any other form of non-transitory storage medium known in the art. The one or more non-transitory processor-readable storage media 730 may store sets of instructions, or units and/or modules that include the sets of instructions, for conducting operations and/or method steps described in the present disclosure. Alternatively, the units and/or modules may be hardware disposed in the terminal 700 configured to conduct operations and/or method steps described in the present disclosure. The one or more processors may be configured to execute the sets of instructions and perform the operations in example embodiments of the present disclosure.

Merely for illustration, only one processor will be described in terminals that execute operations and/or method steps in the following example embodiments. However, it should be note that the terminals in the present disclosure may also include multiple processors, thus operations and/or method steps that are performed by one processor as described in the present disclosure may also be jointly or separately performed by the multiple processors. For example, if in the present disclosure a processor executes both step A and step B, it should be understood that step A and step B may also be performed by two different processors jointly or separately in the terminal (e.g., the first processor executes step A and the second processor executes step B, or the first and second processors jointly execute steps A and B).

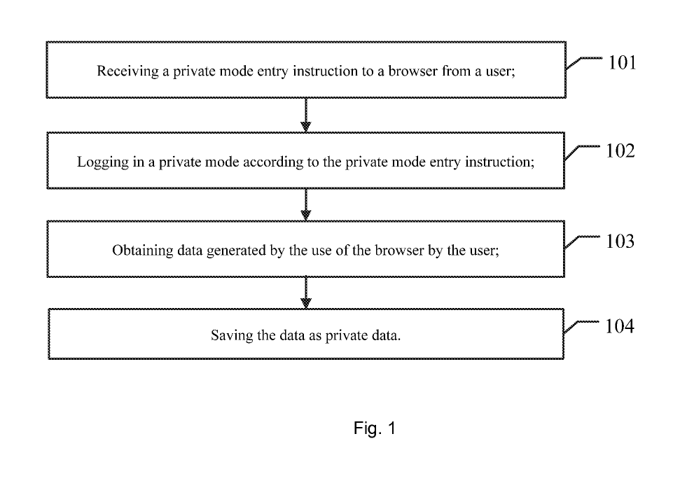

FIG. 1 is a schematic diagram of a method for browser data protection according to example embodiments of the present disclosure. The method may be implemented in the terminal 700. For example, the method may be stored in the storage medium 730 as a set of instructions, which may be executed by the processor 722 to perform steps in the method.

In step 101, a browser may acquire a private mode entry instruction.

According to example embodiments of the present disclosure, a terminal may have a browser installed therein. A user may use the browser in the terminal in at least 2 modes, such as a private mode and a non-private mode. The user may choose to use the browser in the private mode or the non-private mode. The private mode is a personal data protection mode in the browser wherein certain personal data generated in the private mode will not be accessible by others outside the private mode, whereas in the non-private mode the personal data are not protected as in the private mode. In the private mode, all data generated by the browser is private data. Private data may only be displayed in the private mode. Accordingly, all data generated by the browser in the non-private mode are non-private data. When in the non-private mode, the browser may not display private data.

According to example embodiments of the present disclosure, the browser may acquire an instruction to enter into the private mode and such private mode entry instruction may be generated by an operation the user conducted on the browser.

In step 102, the browser may log in the private mode according to the private mode entry instruction.

According to the example embodiments of the present disclosure, after acquiring the private mode entry instruction, the browser may log in the private mode according to the private mode entry instruction (i.e., switching from the non-private mode to the private mode). The private mode entry instruction may require a match between an account identification and a password. The account password may be a string of numbers, letters, characters, punctuation marks, or a combination thereof. Alternatively, the account password may also be a stroke and/or slide operation the user conducted over a touch screen of the terminal. The match may also be the user's finger print. For example, the terminal may first scan the finger print of the user through a sensor in the terminal and save the finger print information as a reference in a storage medium of the terminal. When the user tries to enter into the provide mode of the browser, the user may scan his/her finger over the sensor again. The terminal may compare the scanned fingerprint with the reference. If the two matches, then the terminal may log into the private mode of the browser.

In Step 103, the browser may acquire and/or obtain data generated by operations of the browser.

According to the example embodiments of the present disclosure, after the browser logs in the private mode, the user may conduct operations on the browser to acquire and/or obtain the data generated by operations of the browser in both private mode and non-private mode. For example, the data may be browsing records, bookmarks saved by the user, and cookies, etc. when the browser was operated in both the private mode and non-private mode.

In step 104, the terminal may save data generated during operations in private mode as private data.

According to the example embodiments of the present disclosure, when the current mode of the browser is the private mode, the browser may save the acquired data as private data. When the current mode of the browser is the non-private mode, the browser may save the acquired data as non-private data. When the user requests to display the data, such data may only be displayed when the browser is in the private mode. When the browser is in the non-private mode, private data may not be displayed to keep confidentiality of the user.

According to the example embodiments of the present disclosure, after receiving the private mode entry instruction from the user, the terminal may log in the private mode of the browser according to the private mode entry instruction. In the private mode, the data generated by operations of the browser may be saved as private data. The private data may be displayed only when the browser is in the private mode. When the browser is in the non-private mode, the browser may not display the private data.

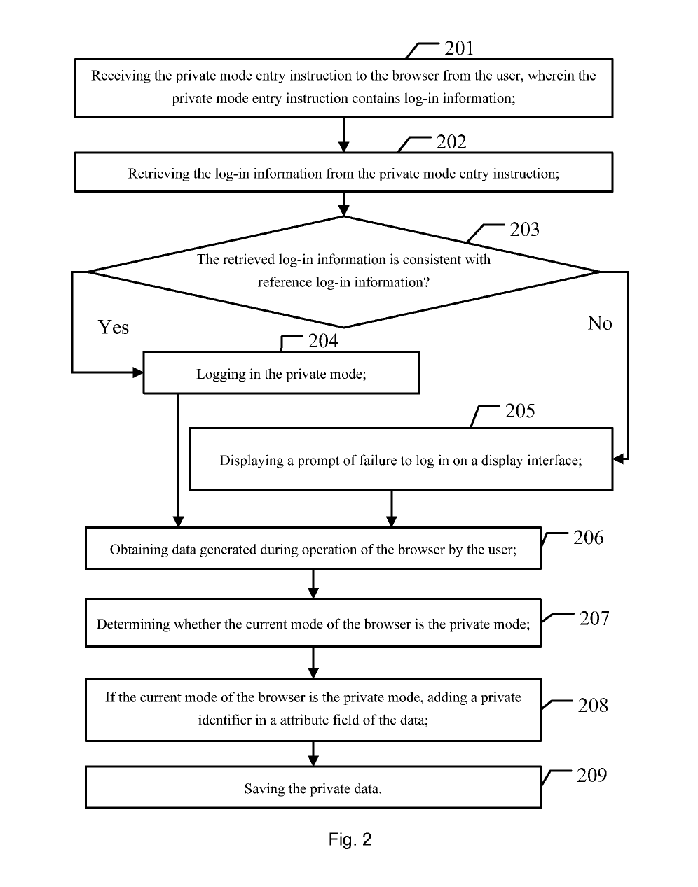

FIG. 2 is another schematic diagram of a method for browser data protection according the example embodiments of the present disclosure. The method may be implemented in the terminal 700. For example, the method may be stored in the storage medium 730 as a set of instructions, which may be executed by the processor 722 to perform steps in the methods.

In step 201, the browser may acquire and/or obtain the private mode entry instruction, wherein the private mode entry instruction may include log-in information of the private mode input by a user.

According to the example embodiments of the present disclosure, the user may operate on the browser to log in the private mode from the non-private mode, and then use the browser in the private mode. To log in, the terminal may display a log-in interface to the user. The user may input the log-in information at the display interface of the browser to generate the private mode entry instruction. The private mode entry instruction may contain the log-in information of the private mode input by the user. The log-in information may include an account identification (ID) and a password, or just a password. The log-in information may be a string of numbers, letters, characters, punctuation marks, or a combination thereof. Alternatively, the log-in information may be a predetermined stroke and/or slide operation the user conducted over a touch screen of the terminal. The log-in information may also be the user's finger print. For example, the terminal may first scan the finger print of the user through a sensor in the terminal and save the finger print information in a storage medium of the terminal. When the user tries to enter into the provide mode of the browser, the user may scan his/her finger over the sensor again. The terminal may compare the scanned fingerprint with the one saved in the storage medium. If the two matches, then the terminal may log into the private mode of the browser.

In step 202, the terminal may operate the browser to acquire and/or obtain the log-in information from the private mode entry instruction.

According to the example embodiments of the present disclosure, after receiving the private mode entry instruction, the browser may retrieve the log-in information of the private mode input by the user from the private mode entry instruction.

In step 203, the browser may operate the browser to verify the log-in information. To this end, the browser may determine whether or not the log-in information from the user is consistent with referenced log-in information saved in the browser in advance, and then determine whether or not to log in to the private mode.

If the retrieved log-in information is consistent with the pre-saved reference log-in information, the terminal may execute step 204; if not, the terminal may execute step 205.

In step 204, the terminal may execute the browser to log in the private mode and then continue to execute step 206. When the browser is switched to private mode, the terminal may change a mode field in the browser. For example, the initial value of the mode field of the browser may be 0, indicating that the browser is in the non-private mode. The terminal may change the mode filed to 1, indicating that the browser is in the private mode.

In step 205, the terminal may execute the browser to display a log-in failure information on the display interface (e.g., the browser interface or the screen of the terminal) of the browser.

According to the example embodiments of the present disclosure, if the retrieved log-in information is consistent with the reference log-in information, it means that the user passes the identification verification and the browser may log in the private mode; if the retrieved log-in information is inconsistent with the reference log-in information, it means that the user identification verification fails, the browser then may remain in the non-private mode and the browser may also display a prompt of log-in failure on the display interface to remind the user that the log-in has failed. The user may choose to give up logging in to the private mode of the browser or the user may input the log-in information of the private mode again so that the browser may enter the private mode.

Step 201 through step 205 describe a process that the browser enters the private mode utilizing the log-in information of the private mode input by the user. In actual applications, the user may also exit from the private mode and enter the non-private mode. For example, the user may select an exit button from the browser to exit the private mode, thereby switching the browser between the private mode and the non-private mode.

In step 206, the terminal may execute the browser to acquire and/or obtain data generated by operations of the browser by the user.

According to the example embodiments of the present disclosure, after the browser switches from the non-private mode to the private mode, the user may use the browser in the private mode. The browser may acquire and/or obtain the data generated by the use of the browser.

In step 207, the terminal may determine whether or not the current mode of the browser is the private mode.

During the operation of the browser, such as when the user is surfing Internet, the browser may need to display the data generated by the user of the browser. For example, the user may wish to see the history record of the browser. In another example, when the user input one or a few letters in an address bar or search bar of the browser, the browser may automatically display website addresses or search keywords that the user input before based on the incomplete letters that the user input in the address bar. Thus the terminal may first retrieve the data generated during the use of the browser. In order to protect the privacy of the user, the terminal may determine, after receiving the data, the terminal may further determine whether or not the current mode of the browser is private. The terminal may treat the data differently according to the status of the mode of the browser.

In step 208, if the current mode of the browser is the private mode, the browser may add a private identifier to an attribute of the data (hereinafter “private data”) that generated when the browser is operated under private mode.

According to the example embodiments of the present disclosure, if it is determined that the current mode of the browser is the private mode, the terminal may add a private identifier in the attribute of the received private data to distinguish the private data with data (hereinafter “non-private data”) generated when the browser is operated in non-private mode.

In step 209, the terminal may save the private data.

According to the example embodiments of the present disclosure, the terminal may save the private data, wherein the private data may be saved in the same memory area as the non-private data, or alternatively, the private data may be saved in another memory area different from that of the non-private data.

In a similar manner, if the terminal determines that the current mode of the browser is the non-private mode, the terminal may acquire and/or obtain the data generated by the browser and add a non-private identifier to the attribute of the data so as to identify the data as non-private data. The terminal may save the non-private data for future use as well.

The private data may be displayed to the user only when the browser is operated under private mode. The non-private data may be displayed to the user when the browser is operating in the non-private mode, or when the browser is operating in both the private mode and the non-private mode. When the private data and non-private data are displayed together, the terminal may distinguish the private data from the non-private data. For example, the terminal may display the private data above the non-private data and/or display the text of the private data with a different font, color, or format from the non-private data. Alternatively, the non-private data may be displayed to the user only when the browser is operated under non-private mode.

Thus, the example embodiments of the present disclosure provide a browser that allows a user to switch the browser between a non-private mode and a private mode without logging in or out of a current operation system. After acquiring the log-in information input by the user from the acquired private mode entry instruction, the browser may verify the log-in information by determining whether or not the log-in information is consistent with the reference log-in information saved in the terminal. If such log-in information is verified, the browser may log in the private mode; if such log-in information fails the verification, a prompt may be displayed to indicate failure to log-in the private mode. Moreover, after the browser logs in to the private mode, the user may continue to use such browser. The browser may also acquire the data generated by the use of such browser by the user. If the browser is in the private mode, a private identifier may be added in the attribute of the acquired data to identify the data as private data. The private data then may be saved in the terminal. The private data may be displayed to the user only when the browser is in the private mode. In a similar manner, the terminal may also save non-private data. The non-private data may be displayed to the user when the browser is operated under both the private mode and the non-private mode. Thus the data confidentiality may be effectively improved; user privacy may be protected; and the user experience may be enhanced.

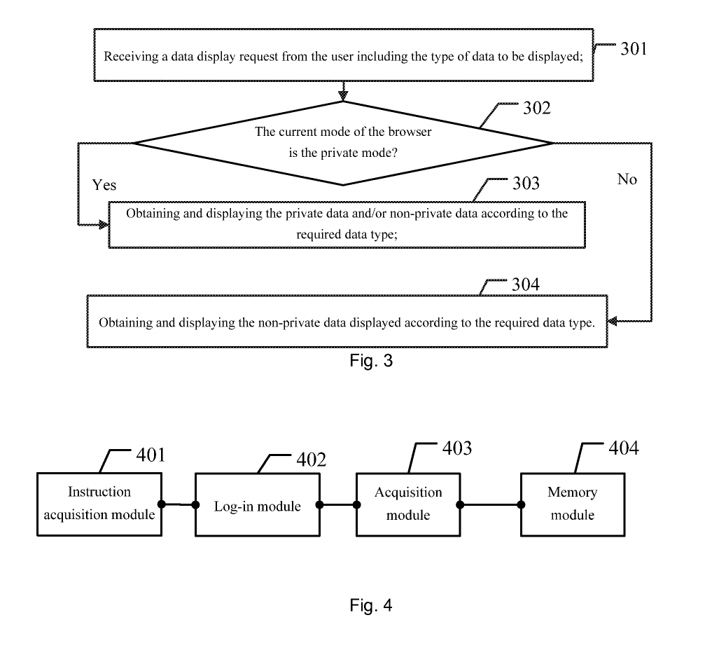

FIG. 1 and FIG. 2 relate to methods that the browser enter into the private mode and save private data. FIG. 3 is a schematic diagram of a method for reading the private data according to the example embodiments of the present disclosure. The method may be implemented in the terminal 700. For example, the method may be stored in the storage medium 730 as a set of instructions, which may be executed by the processor 722 to perform the steps in the method.

In step 301, the terminal may receive a data display request from the user through the browser, wherein the data display request may contain information to define a type of data to display.

During the course of using the browser, the user not only may generate data but also may request to view the data. The browser may receive a data display request from the user, wherein the data display request may contain definition of the type of data the user requests to display. For example, the user may request the terminal to display browsing records of the user and/or bookmarks saved by the user in the browser.

In step 302, the terminal may determine whether or not the current mode of the browser is the private mode; if yes, the terminal may execute step 303; if not, the terminal may execute step 304.

After receiving the data display request, the terminal may determine whether the current mode of the browser is the private mode. For example, the browser may exam the mode field in the browser to determine the current mode of the browser. For example: if such mode field is 0, the terminal may determine that the current mode of the browser is the non-private mode; if such mode field is 1, the terminal may determine that the current mode of the browser is the private mode.

In step 303, the terminal may obtain and display the private data and/or non-private according to the required data type.

After receiving the data display request from the user, the terminal may execute the browser and determine whether the current mode of the browser is the private mode. When the current mode of the browser is the private mode, the terminal may acquire the private data of the corresponding type from the saved private data and display the acquired private data. For example: if the data type requirement contained in the data display request is bookmark data, the terminal may acquire and display only the private data that belong to bookmark type.

Further, when the user requests to display data while the browser is in the private mode, at the same time of displaying private data, the browser may also acquire and display the requested type of data in the non-private data.

In step 304, the terminal may acquire and display non-private data according to the requested data type.

After receiving the data display request from the user, the terminal may determine whether the current mode of the browser is in the private mode. When the current mode of the browser is the private mode, the terminal may acquire the non-private data of the corresponding type from the saved non-private data and display the acquired non-private data. For example, if the data type contained in the data display request is a browsing record, the terminal may acquire the required type of non-private data as well as the required type of private data and display both type of data to the user.

According to example embodiments of the present disclosure, after receiving the data display request from the user, if the current mode of the browser is the private mode, the terminal may acquire and/or obtain and display the private data and the non-private data of the corresponding type from the saved private data (alternatively, the terminal may acquire and/or obtain and display only the private data); if the current mode of the browser is the non-private mode, according to the data type requested in the data display request, the terminal may acquire and/or obtain and display the non-private data so that private data can only be displayed when the browser is in the private mode. Thus the data confidentiality may be effectively improved, the user privacy may be protected, and the user experience may be enhanced.

Below is an example application that the above disclosed methods may be implemented. The application only serves as an example of the methods for better understanding of the methods. One of ordinary skill in the art would understand at the time of the filing of this disclosure that the methods may be applied in any applicable scenarios.

A user is using a web browser installed on a cell phone of the user. The current mode of the browser is a non-private mode. The user clicks a private mode log-in identifier displayed on the display interface of the browser. In response to the click, the browser pops up a window on the display interface requiring the user to input log-in information. The user then inputs the log-in information in the pop up window and the cell phone verifies the log-in information. For example, the user inputs a log-in password 123456. After detecting that the user inputs the log-in password 123456, the browser will determine whether or not the log-in password 123456 is consistent with a reference log-in password saved by the browser in advance; if it is consistent, the browser logs in to the private mode and the user can use the browser in the private mode; if it is inconsistent, a prompt is popped up to remind the user of the password is incorrect and the browser fails to log in the private mode.

After the browser logs in to the private mode, the user may continue to use such browser and acquire the data generated by operations of the browser by the user, such as browsing records, bookmarks saved by the user, and cookies. Taking browsing records as an example, after acquiring the browsing records of the use of the browser by the user, the browser will further determine whether or not the current mode of the browser is the private mode. If the current mode of the browser is the private mode, a private identifier is added in the browsing records to identify such browsing records as private data. The browsing records, which have been identified as private data, are then saved in the cell phone.

The user can also request to view data and generate data display requests via the browser operation. The browser may acquire the data display request of the user and in the event that the data type contained in such request is a browsing record, the browser determines whether or not the current mode of the browser is the private mode; if it is the private mode, the private data, the data type of which is the browsing record, is acquired from the saved private data and the acquired private data is displayed; if it is the non-private mode, the non-private data, the data type of which is the browsing record, is acquired from the saved non-private data and the acquired non-private data is displayed.

FIG. 4 is a schematic diagram of a structure of a browser according to the example embodiments of the present disclosure. The browser may be installed in and operated by the terminal 700.

The browser may include an instruction acquisition module 401, configured to acquire and/or receive the private mode entry instruction; a log-in module 402, configured to log in to the private mode according to the private mode entry instruction, after the instruction acquisition module 401 receives the private mode entry instruction; an acquisition module 403, configured to acquire and/or obtain data generated by operations of the browser by the user, after the log-in module 402 logs in to the private mode; and a memory module 404, configured to save the data as private data after the acquisition module 403 may acquire and/or obtain the data.

According to the example embodiments of the present disclosure, the instruction acquisition module 401 may first acquire and/or receive the private mode entry instruction from the user of the terminal, then according to such private mode entry instruction, the log-in module 402 may log in to the private mode. Then the acquisition module 403 may acquire and/or obtain the data generated by operations of the browser by the user. Finally, the memory module 404 may save the data as private data.

After acquiring the private mode entry instruction, the browser may log in to the private mode accordingly. In the private mode, the data, which is generated by operations of the browser by the user and acquired by the browser, may be saved as private data which may be displayed only when the browser is in the private mode. When the browser is in the non-private mode, the browser may not be allowed to display the private data in order to improve data confidentiality.

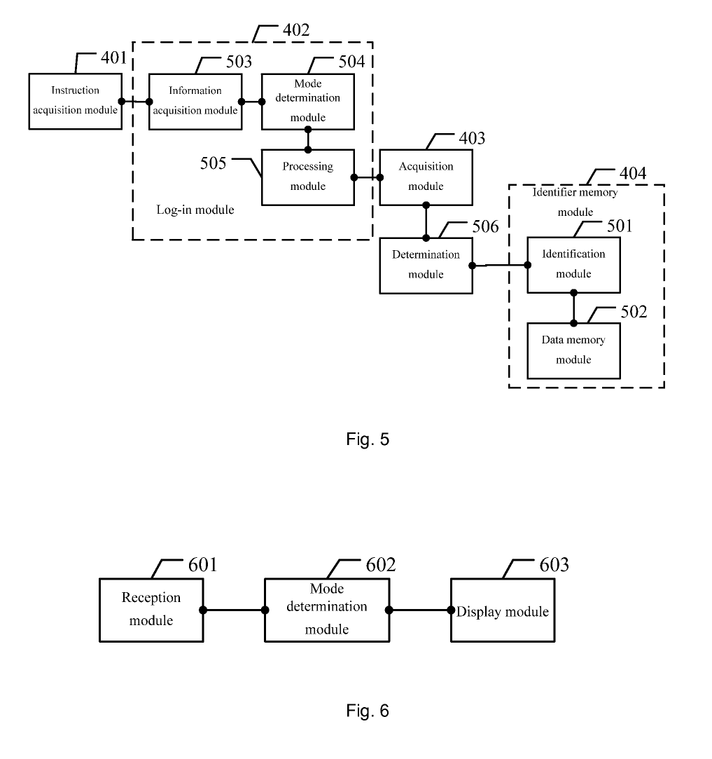

FIG. 5 is another schematic diagram of the structure of a browser according to the example embodiments of the present disclosure. The browser may be installed and operated by the terminal 700.

The browser in FIG. 5 may include the modules as described in the embodiment shown in FIG. 4, i.e., the browser in FIG. 5 may include the instruction acquisition module 401, the log-in module 402, the acquisition module 403, and the memory module 404, as shown in FIG. 4. Further, the modules in FIG. 5 may include the following structures:

The memory module 404 may include an identification module 501, configured to generate private data by adding a private identifier in the attribute field of data generated by operations of the browser when the browser is in private mode, after the acquisition module 403 may acquire and/or obtain the data.

The memory module 404 may also include a data memory module 502, configured to save the private data after the identification module obtains the private data.

According to the example embodiments of the present disclosure, the private mode entry instruction contains the log-in information of the private mode input by the user. Accordingly, the log-in module 402 include an information acquisition module 503, configured to retrieve the log-in information from the private mode entry instruction; a mode determination module 504, configured to determine whether or not the retrieved log-in information (which is the log-in information input by the user) is consistent with the reference log-in information saved by the browser in advance; a processing module 505, configured to log in to the private mode if the mode determination module 504 determines the log-in information is consistent with the log-in information saved by the browser in advance, and to display a prompt of failure to log in information on the display interface if the mode determination module 504 determines the retrieved log-in information is inconsistent with the reference log-in information.

According to example embodiments of the present disclosure, the browser may further include a determination module 506, configured to determine whether or not the current mode of the browser is the private mode after the acquisition module 401 acquire and/or obtain the data, and to execute the memory module 404 when the current mode of the browser is determined to be the private mode.

According to example embodiments of the present disclosure, after the instruction acquisition module 401 receives the private mode entry instruction, the information acquisition module 503 in the log-in module 402 may retrieve the log-in information from the private mode entry instruction and the mode determination module 504 may determine whether or not the retrieved log-in information is consistent with the reference log-in information saved by the browser in advance; if the mode determination module 504 determines that the retrieved log-in information is consistent with the reference log-in information, the processing module 505 may log in to the private mode; if the mode determination module 504 determines that the retrieved log-in information is inconsistent with the reference log-in information, the processing module 505 may display a prompt of failure to log in on the display interface.

After the browser logs in to the private mode, the acquisition module 403 may acquire and/or obtain the data generated by operations of the browser by the user and then the determination unit 506 may determine whether or not the current mode of the browser is the private mode; if the current mode is determined to be the private mode, the identification module 501 may add the private identifier in the attribute field of the data so that the terminal may identify the data as private data and the data memory module 502 may save the private data.

Accordingly, after acquiring the log-in information input by the user from the acquired private mode entry instruction, the browser may determine whether or not such log-in information is consistent with the log-in information saved by the browser in advance. If such log-in information is consistent with the log-in information saved by the browser in advance, the browser may log in to the private mode; if such log-in information is inconsistent with the log-in information saved by the browser in advance, a prompt may be displayed to indicate the log-in failure of the private mode. Moreover, after the browser logs in to the private mode, the user may continue to use such browser. The browser may acquire the data generated by the use of such browser by the user. When the browser is in the private mode, a private identifier may be added in the attribute field of the acquired data to obtain the private data, and such private data may be saved so that the private data may only be displayed when the browser is in the private mode. In non-private mode, the terminal may only display non-private data.

FIG. 6 is yet another schematic diagram of the structure of a browser according to the example embodiments of the present disclosure. The browser may be installed and operated by the terminal 700.

The browser in FIG. 6 may include a reception module 601, configured to receive a data display request from the user and the data display request may contain a requirement to the type of data to display; a mode determination module 602, configured to determine whether or not the current mode of the browser is a private mode after the reception module receives the data display request; a display module 603, configured to acquire and display private data according to the data type if the mode determination module 602 determines that the current mode of the browser is the private mode, and further configured to acquire and display non-private data according to the data type if the mode determination module 602 determines that the current mode of the browser is the non-private mode.

According to the example embodiments of the present disclosure, if the browser is currently in the private mode, the display module 603 may further configured to acquire and display non-private data according to said data type and to display the private data using a font, color, format, and/or at a different place different from that of the non-private data.

After the reception module 601 receives the data display request from the user, the mode determination module 602 may determine whether or not the current mode of the browser is the private mode; if the mode determination module 602 determines that the current mode of the browser is the private mode, the display module 603 may acquire and/or obtain and display the private data according to the data type, and alternatively, if the mode determination module 602 determines that the current mode of the browser is the non-private mode, the display module 603 may acquire and/or obtain and display the non-private data according to the data type.

According to the example embodiments of the present disclosure, after receiving the data display request from the user, if the current mode of the browser is the private mode, according to the data type contained in the data display request, the browser may acquire and/or obtain and display the private data of the corresponding type from the saved private data; if the current mode of the browser is the non-private mode, according to the data type contained in the data display request, the browser may acquire and/or obtain and display the non-private data of the corresponding type from the saved non-private data so that private data may be displayed only when the browser is in the private mode.

Those of ordinary skill in the art may understand that all or some of the steps in the methods of the aforementioned embodiments may be embedded into hardware. Alternatively, the methods of the aforementioned embodiments may also be draft as programs and executed by hardware. The programs may be saved in a type of computer-readable non-transitory memory medium. The memory medium may be read-only memory, a disk or compact disk, etc.

While example embodiments of the present disclosure relate to apparatuses and methods for browser data protection, the apparatuses and methods may also be applied to other Applications. For example, the apparatus and methods may be implemented in MS Office software or any other software. In addition to mobile terminals, the methods and apparatus may also be applied to non-mobile devices such as a desk top computer, a server of a network, or any devices that may be operated by a user to browse internet contents, etc. The present disclosure intends to cover the broadest scope of apparatuses and methods for content browsing, generation, and interaction.

Thus, example embodiments illustrated in FIGS. 1-7 serve only as examples to illustrate several ways of implementation of the present disclosure. They should not be construed as to limit the spirit and scope of the example embodiments of the present disclosure. It should be noted that those skilled in the art may still make various modifications or variations without departing from the spirit and scope of the example embodiments. Such modifications and variations shall fall within the protection scope of the example embodiments, as defined in attached claims.

1. A terminal device, comprising:
a non-transitory processor-readable storage medium including a set of instructions for browser data protection; and
a processor in communication with the storage medium, the processor being configured to execute the set of instructions to:
operate a browser installed in the terminal, wherein the browser includes a private mode and a non-private mode;
switch the browser from the non-private mode to the private mode in response to a private mode entry instruction received from the user; and
obtain data associated with activities of a user on the browser, based on the private mode and non-private mode of the browser.

2. The terminal device of claim 1, wherein the browser is an Internet browser; and
wherein the data is at least one of bookmark data and browsing history data.

3. The terminal device of claim 1, wherein the processor is further configured to execute the set of instructions to:
identify the data obtained when the browser is in the private mode by adding a private identifier in an attribute field of the data;
identify the data obtained when the browser is in the non-private mode by adding a non-private identifier in the attribute field of the data; and
save the data.

4. The terminal device of claim 1, wherein the private mode entry instruction comprises log-in information of the private mode input by the user;
wherein to switch the browser from the non-private mode to the private mode the processor is further configured to execute set of instructions to:
retrieve the log-in information from the private mode entry instruction;
determine whether the retrieved log-in information is consistent with reference log-in information pre-stored in the browser; and
switch the browser to the private mode when the retrieved log-in information is consistent with the reference log-in.

5. The terminal device of claim 1, wherein to switch the browser from the non-private mode to the private mode the processor is further configured to execute the set of instructions to:
retrieve the log-in information from the private mode entry instruction;
determine whether the retrieved log-in information is consistent with a reference log-in information; and
provide failure to log-in information on an interface of the browser when the retrieved log-in information is inconsistent with the reference log-in information.

6. The terminal device of claim 1, wherein the processor is further configured to execute the set of instructions to:
receive a data display request from the user;
display the data obtained when the browser is in the private mode and the data obtained when the browser is in the non-private mode together in response to the data display request when the browser is in the private mode; and
display the data obtained when the browser is in the non-private mode only in response to the data display request when the browser is in the non-private mode.

7. The terminal device of claim 6, wherein the processor is further configured to execute the set of instructions to:
display the data obtained when the browser is in the private mode and the data obtained when the browser is in the non-private mode differently in at least one aspect of text font, text position, text color, and text format.

8. A method for browser data protection, the method comprising:
providing a browser operating in a terminal device to a user, wherein
the terminal device includes a processor, and
the browser includes a private mode and a non-private mode;
switching, by a, the browser from the non-private mode to the private mode in response to a private mode entry instruction received from the user; and
obtaining, by a processor, data associated with activities of a user on the browser, based on the private mode and non-private mode of the browser.

9. The method of claim 8, wherein the browser is an Internet browser; and
wherein the data is at least one of bookmark data and browsing history data.

10. The method of claim 8, further comprising:
identifying, by a processor, the data obtained when the browser is in the private mode by adding a private identifier in an attribute field of the data;
identifying, by a processor, the data obtained when the browser is in the non-private mode by adding a non-private identifier in the attribute field of the data; and
saving the data by a processor.

11. The method of claim 8, wherein the private mode entry instruction comprises log-in information of the private mode input by the user;
wherein the switching of the browser from the non-private mode to the private mode comprises:
retrieving, by a processor, the log-in information from the private mode entry instruction;
determining, by a processor, whether the retrieved log-in information is consistent with reference log-in information pre-stored in the browser;
switching, by a processor, the browser to the private mode when the retrieved log-in information is consistent with the reference log-in; and
displaying, by a processor, failure to log-in information on an interface of the browser when the retrieved log-in information is inconsistent with the reference log-in information.

12. The method of claim 8, further comprising:
receiving, by a processor, a data display request from the user;
displaying, by a processor, the data obtained when the browser is operated in the private mode and the data obtained when the browser is in the non-private mode together in response to the data display request when the browser is in the private mode; and
displaying, by a processor, the data obtained when the browser is in the non-private mode only in response to the data display request when the browser is in the non-private mode.

13. The method of claim 12, further comprising:
displaying, by a processor, the data obtained when the browser is in the private mode and the data obtained when the browser is in the non-private mode differently in at least one aspect of text font, text position, text color, and text format.

14. A non-transitory processor-readable storage medium, comprising a set of instructions for browser data protection, wherein the set of instructions is configured to direct a processor to perform acts of:
providing a browser operating in a terminal device to a user, wherein
the terminal device includes a processor, and
the browser includes a private mode and a non-private mode;
obtaining data generated by an operation of the browser by the user; and
switching the browser from the non-private mode to the private mode in response to a private mode entry instruction received from the user.

15. The storage medium of claim 14, wherein the browser is an Internet browser; and
wherein the data is at least one of bookmark data and browsing history data.

16. The storage medium of claim 14, wherein the set of instructions is further configured to direct the processor to perform acts of:
identifying the data obtained when the browser is in the private mode by adding a private identifier in an attribute field of the data;
identifying the data obtained when the browser is in the non-private mode by adding a non-private identifier in the attribute field of the data; and
saving the data.

17. The storage medium of claim 14, wherein the private mode entry instruction comprises log-in information of the private mode input by the user;
wherein the switching of the browser from the non-private mode to the private mode comprises:
retrieving the log-in information from the private mode entry instruction;
determining whether the retrieved log-in information is consistent with reference log-in information pre-stored in the browser; and
switching the browser to the private mode when the retrieved log-in information is consistent with the reference log-in.

18. The storage medium of claim 14, wherein the switching of the browser from the non-private mode to the private mode further comprises:
retrieving the log-in information from the private mode entry instruction;
determining whether the retrieved log-in information is consistent with a reference log-in information; and
providing failure to log-in information on an interface of the browser when the retrieved log-in information is inconsistent with the reference log-in information.

19. The storage medium of claim 14, wherein the set of instructions is further configured to direct the processor to perform acts of:
receiving a data display request from the user;
displaying the data obtained when the browser is operated in the private mode and the data obtained when the browser is in the non-private mode together in response to the data display request when the browser is in the private mode; and
displaying the data obtained when the browser is in the non-private mode only in response to the data display request when the browser is in the non-private mode.

20. The storage medium of claim 19, wherein the set of instructions is further configured to direct the processor to perform acts of:
displaying the data obtained when the browser is in the private mode and the data obtained when the browser is in the non-private mode differently in at least one aspect of text font, text position, text color, and text format.
